(19) United States
(12) Patent Application Publication
(10) Pub. No.: US 2005/0262150 A1
(43) Pub. Date: Nov. 24, 2005

(54) Object-based storage

(75) Inventor: Anand Krishnaswamy, Andhra Pradesh (IN)

Correspondence Address: CARTER, DELUCA, FARRELL & SCHMIDT, LLP, 445 BROAD HOLLOW ROAD, SUITE 225, MELVILLE, NY, 11747, US

(73) Assignee: Computer Associates Think, Inc.

(21) Appl. No.: 11/134,791

(22) Filed: May 20, 2005

Related U.S. Application Data
(60) Provisional application No. 60/573,554, filed on May 21, 2004.

(51) Int. Cl. G06F 7/00

(52) U.S. Cl. 707/104.1

(57) ABSTRACT

A system and method for object-base storage are disclosed. The system includes a storage media including at least one block, the storage media configured to store at least one object in the at least one block, a metadata server for storing identification information concerning of the at least one block, and a computing node including a software layer configured to communicate with the metadata server to obtain the identification information, the software layer further configured to access the at least one object based on the identification information.

### CROSS-REFERENCE TO RELATED APPLICATIONS

This patent application claims priority to U.S. Provisional Patent Application Ser. No. 60/573,554 filed on May 21, 2004, the contents of which are hereby incorporated by reference herein.

### BACKGROUND

1. Field of the Disclosure

The present disclosure generally relates to object-based storage management systems. More particularly, the present disclosure relates to a new software layer configured to manage intelligently an object-based storage system.

2. Description of the Related Art

Traditional data storage has been generally based on block-based interfaces, such as SCSI and ATA/IDE. These architectures rely on unintelligent storage devices, such as disk drives (e.g., hard drives, CD-ROMs, etc.) which store data in blocks, i.e., discrete and static segments of the disk drives, and files, i.e., higher-level abstraction schemes that enable secure data sharing across different operating system platforms. Since traditional block and file systems provide data access by storing data within block and metadata within files, file servers were used to maintain the metadata (e.g., attributes of the data) and to authenticate I/O access. This arrangement suffers from a bottleneck at the file server as well as limited security and data sharing. Object-based storage (OBS) does not store data in files and blocks but instead uses objects which have a number of advantages over static file and block based systems eliminating the bottleneck.

Currently, OBS is hard to implement because conventional storage devices are not aware of the users and software applications using the storage, since these devices need to understand the relationships between the blocks and files on the device and the desired objects. OBS is implemented using object storage devices (OSD), which are intelligent devices capable of continually learning important characteristics of the data storage and mapping the data into desired objects. OBS treats an object as a primitive storage segment (e.g., a block) stored on a data storage server and metadata concerning the object is maintained in a metadata server. A computing node (e.g., a client, personal computer, etc.) which requires access to the object requests from the metadata server the ID of the object and then directly accesses the OSD with the object ID. However, OSD being intelligent devices require their own central processing unit(s), memory, network connectivity, and internal logic. Therefore, OSDs are expensive to implement within existing data storage networks since existing storage devices would be made obsolete and would need to be replaced.

Therefore, there is a need for object-based storage which can be implemented using existing storage infrastructure based on disk drives, arrays, etc. without relying on OSDs.

### SUMMARY

Disclosed is a system and method for object-based storage. The system includes storage media for storing object data within one or more blocks and a metadata server, which acts as a directory and stores identification information concerning the blocks of the objects. The system further includes a computing node which includes a software layer for communicating with the metadata server and the storage media, a security layer for restricting access to the storage media, and a device driver to enable low level communication between the computing node and the storage media. The software layer obtains identification information concerning the blocks from the metadata server and thereafter accesses the blocks on the storage media.

According to one embodiment of the present disclosure, a system for storing data in at least one object is provided. The system includes a storage media including at least one block, the storage media configured to store the at least one object in the at least one block, a metadata server for storing identification information concerning of the at least one block, and a computing node including a software layer configured to communicate with the metadata server to obtain the identification information, the software layer further configured to access the at least one object based on the identification information.

According to another embodiment of the present disclosure, a method for storing data in at least one object is provided. The method includes the steps of requesting access to the at least one object through a computing node including a software layer, wherein the at least one object is stored in at least one block of storage media, communicating with a metadata server configured to store identification information concerning of the at least one block to obtain the identification information, and communicating with the storage media to access the at least one object-based on the identification information.

According to a further embodiment of the present disclosure, a set of computer-executable instructions for storing data in at least one object is provided. The computer-executable instructions includes the steps of requesting access to the at least one object through a computing node including a software layer, wherein the at least one object is stored in at least one block of storage media, communicating with a metadata server configured to store identification information concerning of the at least one block to obtain the identification information, and communicating with the storage media to access the at least one object-based on the identification information.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a block diagram generally illustrating components of an object-based storage system in accordance with the present disclosure;

FIG. 2 is a computing node for implementing various embodiments of the present disclosure;

FIG. 3 is a flow diagram illustrating a method for reading an object in the object-based storage system in accordance with the present disclosure; and

FIG. 4 is a flow diagram illustrating a method for writing an object in the object-based storage system in accordance with the present disclosure.

### DETAILED DESCRIPTION

Preferred embodiments of the present disclosure will be described herein below with reference to the accompanying drawings. In the following description, well-known functions or constructions are not described in detail to avoid obscuring the present disclosure in unnecessary detail.

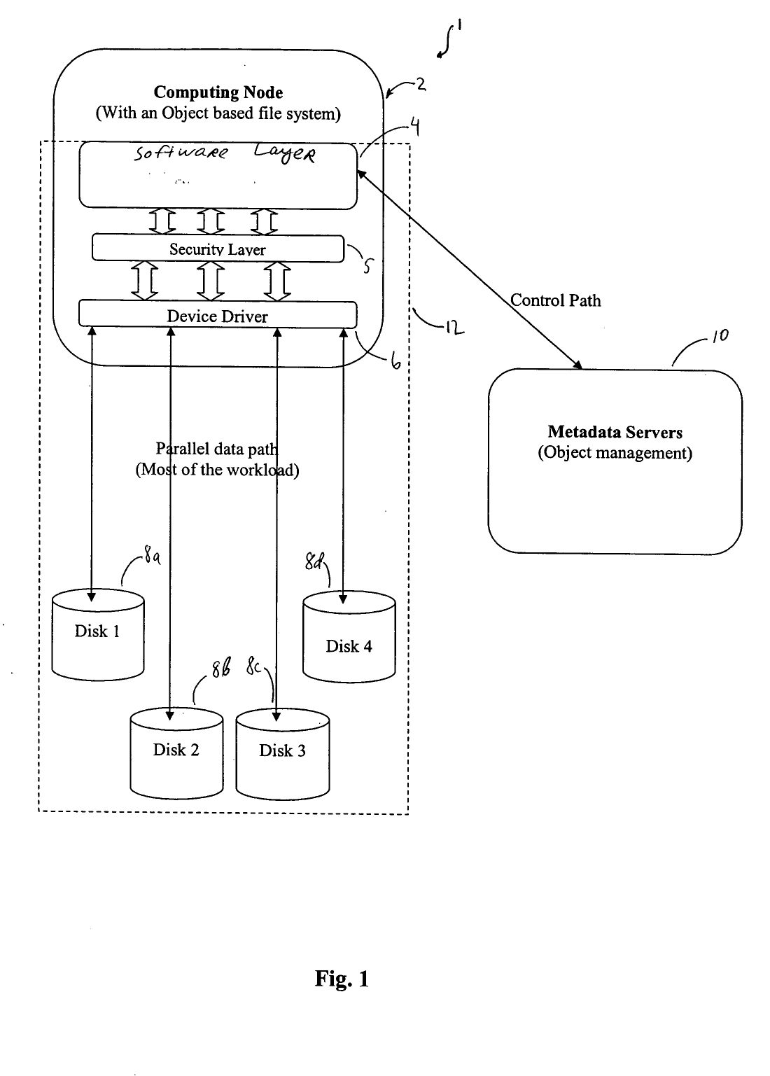

With reference to FIG. 1, an object-based storage (OBS) system is shown. The OBS system 1 includes at least one computing node 2 having an object-based file system, a software layer 4, and at least one device driver layer 6 for communicating with a plurality of storage media 8a-d.

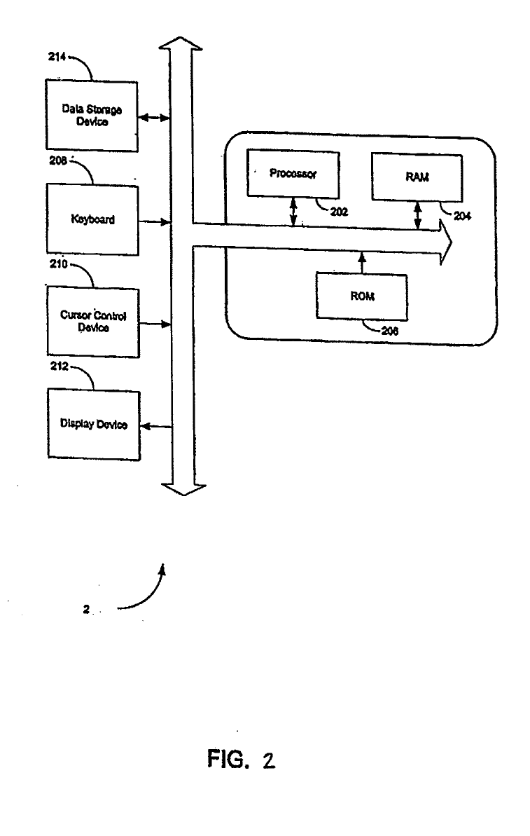

Referring to FIG. 2, the computing node 2 is shown including a data storage device 214 such as a hard drive, magnetic media, optical media, etc., and read only memory (ROM) 206. The computing node 2 comes equipped with a processor 202 and random access memory (RAM) 204. In additional, the computing node 2 is configured with a keyboard 208, mouse or other pointing device 210 and a display 212.

The computer-executable instructions may be loaded from the data storage device 214 to RAM 204 from which the processor 202 reads and executes each instruction, or the processor may access and execute the instructions directly from ROM 206 depending on the manner in which the instructions are stored.

The software function to be processed may be selected through a combination of keystrokes on the keyboard 208 and manipulation of the pointing device 210, as known in the art. The display device 212, ideally, provides a graphical interface allowing easy visualization of the file storage structure of the data storage device 214 as well as a graphical representation of the process outputs during and after execution. It is also envisioned that the current method may be used with a plurality of computing nodes 2 arranged in a network (e.g., LAN, WAN, wireless, etc.).

Referring back to FIG. 1, the software layer 4 lies above the device driver layer 6 and in conjunction with the driver layer 6, a security layer 5, and at least one storage media 8a-d form an OSD emulator 12. The software layer 4 includes buffers which serve as cache as well as processing space and intercepts requests for objects accessed from the computing node 2, which are then parsed therein according to known in the art device instructions. The device driver layer 6 includes low level device instructions which enable the computing node 2 to communicate with the storage media 8a-d.

The storage media 8a-d may be the data storage device 214 of the computing node 2 or may be part of another computing system (e.g., a storage server). The storage media 8a-d may be disk drive arrays (e.g., redundant arrays of independent disks [RAID]) configured to store the objects.

Objects combine the technology of files and blocks. Similar to blocks, objects are units of storage which can be accessed directly on the storage media 8a-d (e.g, without going through a server as required with a file). Similar to files, objects can be accessed using an interface configured to abstract storage applications (e.g., operating system) from metadata. Furthermore, objects can be of variable size and can be used to store entire data structures, such as files, databases, images, video, music, and any fragment of data. This allows for objects to be created to suit specific user and/or software application needs.

In addition to including data, objects also include certain attributes which contain information concerning the object including static information (e.g., creation time), dynamic information (e.g., last modified time), information specific to a storage application (e.g., filename, group, etc.), information specific to a use (e.g., quality of service [QoS] agreement), etc. Other types of attributes may contain information concerning the object's behavior such as the expected read/write ratio, possible patterns of access, expected lifetime of the object.

The data encompassed by the object is stored in blocks on the storage media 8a-d and the metadata of the object (e.g., the object attributes are stored on the metadata server 10). The attributes are used by a metadata server 10 to identify which objects are being requested by the computing node 2 and grant access thereto. The metadata server 10 is connected to the software layer 4 from which the metadata server receives the object requests once the software layer 4 has parsed the requests. In addition, the metadata server 10 acts as a directory to the blocks of the requested object and, once a request for a certain object is received, the metadata server 10 acts as a gatekeeper. More particularly, the metadata server 10 authorizes the computing node 2 to access the objects and provides the software layer 4 with the location (e.g., ID of the storage media 8a-d) of the object. Based on the identification information, the software layer 4 retrieves the blocks of the object and reconstructs the object based on the request by the computing node 2.

The OSD emulator 12 also includes the security layer 5 which may be a software application which restricts access to the storage media 8a-d by authorizing only specific retrieval and/or creation of objects and corresponding blocks stored in the storage media 8a-d. More specifically, the security layer 5 limits access only to the requesting computing node 2 (e.g., requesting access to read or write an object), only for the specific blocks associated with the object being requested by the computing node 2, and only for a specified duration of time.

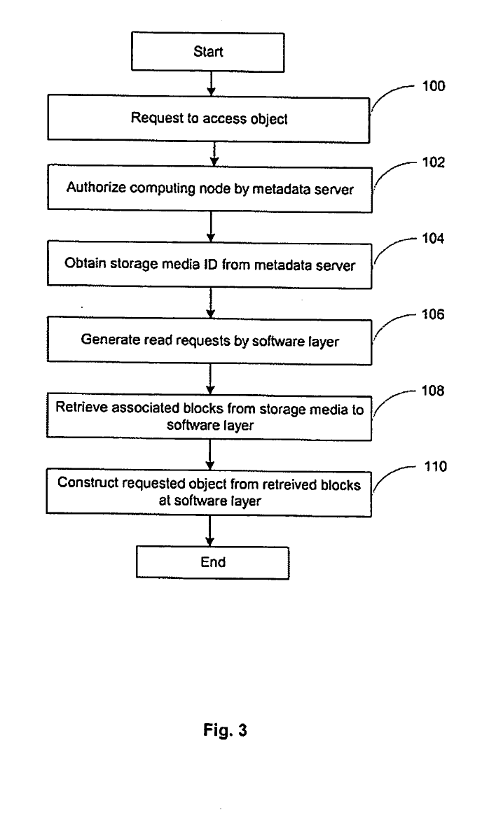

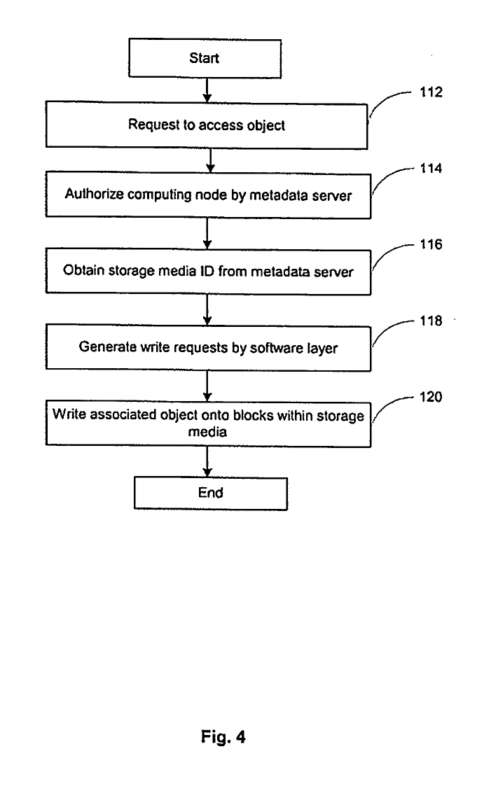

Reading (e.g., retrieval) and writing (e.g., creation) of objects is discussed with reference to FIGS. 3 and 4. A method for reading the object stored on the storage media 8a-d is shown in FIG. 3. In step 100, the computing node 2 initiates a read object command by requesting access to a specified object, the request is processed by the software layer 4, which then transmits the request to the metadata server 10.

The metadata server 10 acts as a directory of the objects stored in the storage media 8a-d. Upon receiving the request, in step 102, the metadata server 10 authorizes the computing node 2. Authorization involves determination whether the computing node 2 may access a specific segment of the storage media 8a-d. For instance, if an object is designated as openable by a specified user, then the metadata server 10 verifies that the user operating the computing node 2 is authorized to access the object.

In step 104, the metadata server 10 supplies the software layer 4 with identifying information (e.g., ID, IP address, etc.) of the storage media 8a-d which contains the blocks of the requested object. The identifying information allows the software layer 4 to target the blocks where the object is located for the reading. It is envisioned that the requested object may contain blocks on a plurality of storage media 8a-d (e.g., storage media 8a, 8c); in that case, the metadata server 10 returns the identifying information concerning the location of the object's blocks (e.g., which one of the storage devices of the storage media 8a-d).

After the identification information concerning the blocks and/or the storage media 8a-d is obtained, the software layer 4 can access the blocks of the requested object stored therein. The security layer 5 is implemented to further limit the accessibility of the blocks to the computing node 2. The security layer 5 may limit access to the computing node 2 by granting access only for a particular time, to a particular segment of the storage media 8a-d, etc. An example of the security layer 5 is eTrust Access Control available from Computer Associates located in Islandia, N.Y.

Once access is granted, in step 106, the software layer 4 generates one or more read requests based on the number of storage devices where the blocks of the requested object are found (e.g., storage media 8a-d). Each read request is also verified by a security layer 5 ensuring that the request is directed to the specified storage device and continues for a specified period of time.

In step 108, the software layer 4 retrieves the blocks of the requested object from the storage media 8a-d. The blocks are retrieved in interleaving fashion as is well known in the art, where after the first block is fetched, the subsequent blocks are pre-fetched. The software layer 4 constructs the requested object from the retrieved blocks allowing the computing node 2 to read the object.

FIG. 4 shows a method for writing an object onto the storage media 8a-d. In step 112, the computing node 2 initiates a write object command by requesting access to create a new object or modify an existing object, the request is processed by the software layer 4, which then transmits the request to the metadata server 10.

Upon receiving the request, in step 114, the metadata server 10 authorizes the computing node 2. In step 116, the metadata server 10 supplies the software layer 4 with identifying information (e.g., ID, IP address, etc.) concerning the blocks and the storage media 8a-d which contains the blocks where the writing will occur. If the blocks of the object to be written span more than one storage device or a desired RAID level is to be achieved, the identifying information for all corresponding storage devices is returned.

If an existing object is being edited, the software layer 4 implements a callback mechanism which will be invoked by the metadata server 10 to prevent another computing node from modifying the same object. If a new object is being created, the software layer 4 retrieves one or more free blocks into which the new object will be written and stores the information concerning the block(s) in the metadata server 10. It is envisioned that other attributes concerning the object are updated within the metadata server 10 as well.

Similar to the reading process discussed above, the security layer 5 controls access to the blocks of the storage media 8a-b. Once access is granted, in step 118, the software layer 4 generates one or more write requests based on the number of storage devices (e.g., number of RAID levels specified) where the blocks of the requested object are found (e.g., storage media 8a-d). Each write request is also verified by a security layer 5 ensuring that the request is directed to the specified storage device and continues for a specified period of time. In step 120, the software layer 4 writes the blocks associated with the object directly onto the storage media 8a-d.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1. A system for storing data in at least one object, the system comprising:
a storage media including at least one block, the storage media configured to store the at least one object in the at least one block;
a metadata server for storing identification information concerning of the at least one block; and
a computing node including a software layer configured to communicate with the metadata server to obtain the identification information, the software layer further configured to access the at least one object based on the identification information.

2. A system as in claim 1, wherein the computing node includes a device driver for communicating with the storage media.

3. A system as in claim 1, further comprising a security layer for restricting access to the storage media.

4. A system as in claim 1, wherein the software layer is configured to read the at least one object by retrieving the at least one block and reconstructing the at least one object.

5. A system as in claim 1, wherein the software layer is configured to modify the at least one object by writing onto the at least one block.

6. A system as in claim 1, wherein the storage media is selected from the group consisting of at least one hard disk, at least one CD-ROM drive, and at least one disk array.

7. A method for storing data in at least one object, the method comprising:
requesting access to the at least one object through a computing node including a software layer, wherein the at least one object is stored in at least one block of storage media;
communicating with a metadata server configured to store identification information concerning of the at least one block to obtain the identification information; and
communicating with the storage media to access the at least one object based on the identification information.

8. A method as in claim 7, wherein the computing node includes a device driver for communicating with the storage media.

9. A method as in claim 7, further comprising a security layer for restricting access to the storage media.

10. A method as in claim 7, wherein the software layer is configured to read the at least one object by retrieving the at least one block and reconstructing the at least one object.

11. A method as in claim 7, wherein the software layer is configured to modify the at least one object by writing onto the at least one block.

12. A method as in claim 7, wherein the storage media is selected from the group consisting of at least one hard disk, at least one CD-ROM drive, and at least one disk array.

13. A set of computer-executable instructions for storing data in at least one object, the computer-executable instructions comprising the steps of:
requesting access to the at least one object through a computing node including a software layer, wherein the at least one object is stored in at least one block of storage media;
communicating with a metadata server configured to store identification information concerning of the at least one block to obtain the identification information; and
communicating with the storage media to access the at least one object-based on the identification information.

14. The computer-executable instructions according to claim 13, wherein the instructions are stored on a computer-readable media, said media selected from a group consisting of magnetic media, optical media, read-only memory (ROM).

15. The computer-executable instructions according to claim 13, wherein the instructions are executable by a computer system comprising a processor, a random access memory (RAM), at least one user input device, a data storage device and a graphical display device.

16. The computer-executable instructions according to claim 13, wherein the computing node includes a device driver for communicating with the storage media.

17. The computer-executable instructions according to claim 13, further comprising a security layer for restricting access to the storage media.

18. The computer-executable instructions according to claim 13, wherein the software layer is configured to read the at least one object by retrieving the at least one block and reconstructing the at least one object.

19. The computer-executable instructions according to claim 13, wherein the software layer is configured to modify the at least one object by writing onto the at least one block.

20. The computer-executable instructions according to claim 13, wherein the storage media is selected from the group consisting of at least one hard disk, at least one CD-ROM drive, and at least one disk array.
